(19) United States
(12) Patent Application Publication
(10) Pub. No.: US 2013/0149986 A1
(43) Pub. Date: Jun. 13, 2013

(54) COMMUNICATION TERMINAL DEVICE AND METHOD FOR ENABLING URGENT COMMUNICATION

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/433,294

(22) Filed: Mar. 29, 2012

(30) Foreign Application Priority Data
Dec. 13, 2011 (CN) 201110414515.2

(51) Int. Cl. H04W 4/22

(52) U.S. Cl. 455/404.1

(57) ABSTRACT

A communication terminal device includes a communication module, a detection unit, a startup module, and a power supply circuit. The communication module is capable of switching between a general communication channel and a special communication channel. When the communication module receives an urgent communication via the special communication channel, the detection unit activates the called communication terminal device if it is in a turned-off state, by providing a startup signal to the startup module, and the startup module controls the power supply circuit to power on the terminal device to accept the urgent communication.

### BACKGROUND

1. Technical Field

The present disclosure generally relates to communication terminal devices, and particularly to a communication terminal device capable of enabling an urgent communication and a method for enabling the urgent communication.

2. Description of Related Art

A communication terminal device, such as a mobile phone, is very necessary for most people. However, when a user needs to call someone in an emergency, if the called user is just on another call or if the mobile phone of the called user is sleeping, the calling user will not be able to contact the called user, with possibly very unfortunate consequences.

What is needed, therefore, is a communication terminal device which can overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic block diagram of a communication terminal device according to an exemplary embodiment.

FIG. 2 is a flowchart of a method of the communication terminal device of FIG. 1 for enabling an urgent communication according to one embodiment.

### DETAILED DESCRIPTION

Reference will be made to the drawings to describe the embodiments.

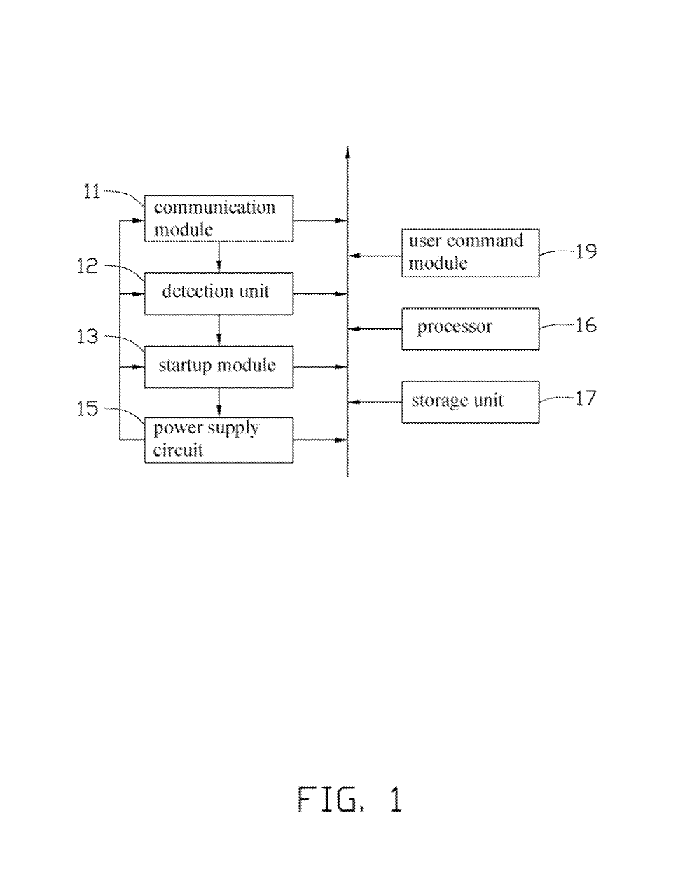

FIG. 1 is a schematic block diagram of a communication terminal device 1 according to an embodiment. The communication terminal device 1 may be a mobile phone, a cordless telephone or other telecommunication terminal In this embodiment, the communication terminal device 1 can not only receive and send general communications via a general communication channel, but can also receive and send urgent communications via a special communication channel, and in particular the communication terminal device 1 can receive and send an urgent communication in any circumstances. In this embodiment, the general communications are in the form of signals through general communication frequencies, and the general communication channel is used to transmit the general communications using the general communication frequencies. For example, four general communication frequencies are usually provided, that is, 850 megahertz (MHZ), 900 MHZ, 1800 MHZ and 1900 MHZ. Thus, the urgent communications should use special communication frequencies different from the general communication frequencies, and a special communication channel is needed to transmit the urgent communications using special communication frequencies.

In this embodiment, not only one or more general communication frequencies and a general communication channel needs to be provided to the communication terminal device 1 for receiving and sending a general communication, but also a special communication frequency and a special communication channel needs to be provided to the communication terminal device 1 for receiving and sending an urgent communication using the special communication frequency via the special communication channel. A user agreement with telecommunication operators and service providers to use the special communication channel for urgent communications is provided.

In this embodiment, the communication terminal device 1 includes a communication module 11, a detection unit 12, a startup module 13, a power supply circuit 15, a processor 16, a storage unit 17, and a user command module 19. The storage unit 17 may be a memory, storing necessary software for the communication terminal device 1 to operate normally.

The communication module 11 may choose between, and is configured to select one of, the general communication channel and the special communication channel to implement a general communication or an urgent communication. The communication module 11 may be a radio frequency module.

The communication terminal device 1 further includes a user interface (not shown), such as special function keys or a touch panel, for example. The user interface is provided to a user for choosing the urgent communication service. When a calling user chooses the urgent communication service via the user interface, the user command module 19 sends a user command to the processor 16, and the processor 16 controls the communication module 11 to select the special communication channel on which an urgent communication may be sent.

The detection unit 12 is configured to determine whether the communication module 11 has received an urgent communication, and to further determine whether the communication terminal device 1 is in a turned-off state (e.g., in a sleep mode). In this embodiment, the turned-off state of the communication terminal device 1 is defined as a situation where the power supply circuit 15 merely provides power to the communication module 11 for urgent communication, the detection unit 12 and the startup module 13, but withholds power to other function modules of the operating system of the device 1, such as a display module of the device 1 for example. That is, when the operating system of the communication terminal device 1 is in the turned-off state, the power supply circuit 15 merely provides power to the necessary circuits and modules which can support or lead to the implement of urgent communication. This turned-off state of the operating system of the communication terminal device 1 can be set by the user via the user interface.

When the communication module 11 receives an urgent communication, if the detection unit 12 determines that the operating system of the communication terminal device 1 is in the turned-off state, the detection unit 12 provides a startup signal to the startup module 13. The startup module 13 controls the power supply circuit 15 to power the whole operating system of the communication terminal device 1 according to the startup signal. Then the processor 16 controls the communication module 11 to connect or access the signals comprising the urgent communication.

If the detection unit 12 determines that the operating system of the communication terminal device 1 is functioning as normal, the detection unit 12 further determines whether the communication module 11 is engaged in a call state (e.g., a state of being connected with another communication device). If the detection unit 12 determines that the communication module 11 is engaged in the call state via the general communication channel, the detection unit 12 provides a signal to the processor 16, the processor 16 controls the communication module 11 to immediately pause the current call, switch to the special communication channel, and connect the urgent communication. In another embodiment, when the processor 16 determines that the communication module 11 receives the urgent communication via the detection unit 12, the processor 16 first issues a warning to the user that an urgent communication is received, via an audible signal provided by the operating system or via a visible signal (e.g., a short text message) displayed on a display panel of the communication terminal device 1, and controls the communication module 11 to then pause the current call, switch to the special communication channel, and connect to the urgent communication.

If the detection unit 12 determines that the communication module 11 is in a standby or vacant state, the processor 16 directly controls the communication module 11 to connect to the urgent communication.

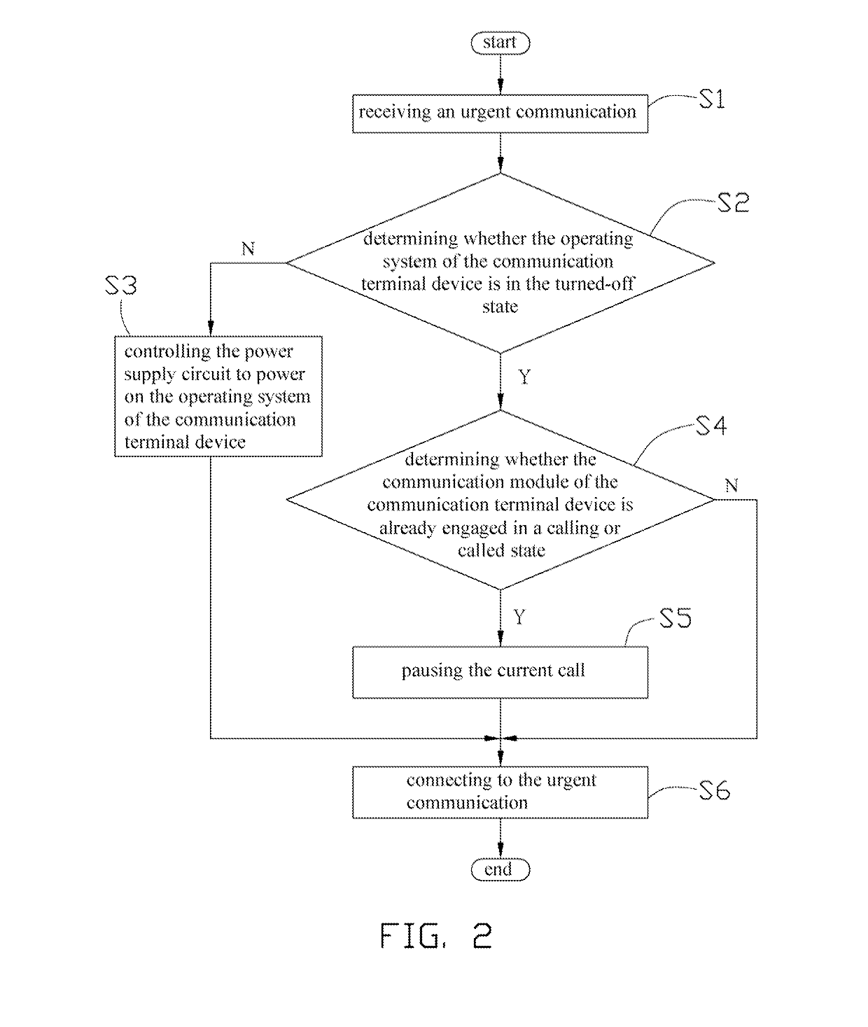

FIG. 2 is a flowchart of a method of the communication terminal device 1 for enabling an urgent communication according to one embodiment. In this embodiment, it is assumed that a calling user uses a communication terminal device 1 to call on the special communication channel a called user who also has another communication terminal device 1, the method of the communication terminal device 1 of the called user includes the following steps.

Step S1 is receiving an urgent communication. In particular, the communication terminal device 1 of the calling user sends a signal indicating an urgent communication with a special communication frequency, and the special communication frequency is different from the general communication frequencies. The urgent communication is transmitted via the special communication channel, and is provided to the communication terminal device 1 of the called user. Then the communication terminal device 1 of the called user receives the signal indicating an urgent communication.

Step S2 is determining whether the operating system of the communication terminal device 1 is in the turned-off state. In particular, when the communication module 11 of the communication terminal device 1 receives an urgent communication, the detection unit 12 detects whether the operating system of the communication terminal device 1 is in the turned-off state. If the detection unit 12 determines that the operating system of the communication terminal device 1 is in the turned-off state, step S3 is performed. If the detection unit 12 determines that the operating system of the communication terminal device 1 is functioning as normal, step S4 is performed.

Step S3 is controlling the power supply circuit 15 to power on the operating system of the communication terminal device 1. In particular, when the detection unit 12 determines that the operating system of the communication terminal device 1 is in the turned-off state, the detection unit 12 provides a startup signal to the startup module 13. The startup module 13 controls the power supply circuit 15 to power on the whole operating system of the communication terminal device 1.

Step S4 is determining whether the communication module 11 of the communication terminal device 1 is already engaged in a calling or called state. In particular, when the detection unit 12 determines that the operating system of the communication terminal device 1 is functioning as normal, the detection unit 12 further determines whether the communication module 11 of the communication terminal device 1 is in the calling or called state. If the detection unit 12 determines that the communication module 11 is in the calling or called state, step S5 is performed. If the detection unit 12 determines that the communication module 11 is not in the calling or called state, step S6 is performed.

Step S5 is pausing the current call. In particular, if the detection unit 12 determines that the communication module 11 is in the calling or called state on the general communication channel, the detection unit 12 provides a signal to the processor 16, the processor 16 causes the communication module 11 to pause the current call and switch to the special communication channel. Before pausing the current call, the processor 16 can first issue a warning to the called user that an urgent communication is received via audible means or by means of the display.

Step S6 is connecting to the urgent communication. In particular, the communication module 11 connects to the urgent communication, and the urgent communication is received and opened.

In summary, the communication terminal device 1 having a function for enabling an urgent communication, even in the case that the communication terminal device 1 being called is in the turned-off state or the communication terminal device 1 is busy in the calling or called state, the communication terminal device 1 can connect to the urgent communication at the same time it is received. That is, the communication terminal device 1 allows the user to receive an urgent call even when the user is on the phone and further provides an audible and a visible signal to warn the user. Also, a display screen and other functionality can be off during a sleep or low powered mode until an urgent call comes through.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A communication terminal device, comprising:
a communication module capable of switching between a general communication channel and a special communication channel, and being configured to receive and send an urgent communication via the special communication channel;
a detection unit configured to determine whether the communication module receives an urgent communication and further determine whether an operating system of the communication terminal device is in a turned-off state;
a startup module; and
a power supply circuit configured to power on the operating system for normal operation state and power on the communication module, the detection unit and the startup module when the operating system is in the turned-off state;
wherein when the communication module receives the urgent communication and the detection unit determines the operating system is in the turned-off state, the detection unit is further configured to provide a startup signal to the startup module, and the startup module is configured to control the power supply circuit to power on the operating system to accept the urgent communication.

2. The communication terminal device of claim 1, wherein the detection unit is further configured to determine whether the communication module is engaged in a call state via the general communication channel when the operating system is functioning as normal.

3. The communication terminal device of claim 2, further comprising a processor, wherein the processor is configured to control the communication module to pause a current call when the communication module is engaged in the call state and the detection unit determines that the urgent communication is received, to switch to the special communication channel and connect to the urgent communication.

4. The communication terminal device of claim 3, further comprising a user command module, wherein the user command module is configured to send a user command to the processor when a user chooses an urgent communication service, and the processor is further configured to control the communication module to switch to the special communication channel according to the user command for sending an urgent communication.

5. The communication terminal device of claim 3, wherein the processor is further configured to issue a warning to a user in a call on the general communication channel when the detection unit determines that the urgent communication is received, and then control the communication module to pause the current call, switch to the special communication channel and connect to the urgent communication.

6. The communication terminal device of claim 5, wherein the processor issues the warning to the user via audible means.

7. The communication terminal device of claim 5, wherein the processor issues the warning to the user by visible means.

8. The communication terminal device of claim 1, wherein the general communication channel is configured to transmit a general communication using a general communication frequency.

9. The communication terminal device of claim 8, wherein the special communication channel is configured to transmit the urgent communication using a special communication frequency.

10. The communication terminal device of claim 9, wherein the special communication frequency is different from the general communication frequency.

11. A method for a communication terminal device to enabling urgent communication, the communication terminal device comprising a communication module, a detection unit, a startup module and a power supply circuit, the method comprising:
receiving an urgent communication via the communication module; and
determining whether an operating system of the communication terminal device is in a turned-off state via the detection unit;
wherein when the detection unit determines that the operating system is in the turned-off state, the detection unit provides a startup signal to the startup module, and the startup module controls the power supply circuit to power on the operating system to accept the urgent communication.

12. The method of claim 11, further comprising determining whether the communication module is engaged in a call state via a general communication channel when the detection unit determines the operating system is functioning as normal.

13. The method of claim 12, further comprising controlling the communication module to pause a current call, switch to a special communication channel, and connect to the urgent communication, when the communication module is engaged in the call state via the general communication channel.

14. The method of claim 12, further comprising issuing a warning to a user in the call that an urgent communication is received, when the communication module is engaged in the call state via the general communication channel.

15. The method of claim 14, further comprising controlling the communication module to pause a current call, switch to a special communication channel, and connect the to the urgent communication.

16. The method of claim 14, wherein the communication terminal device issues the warning to the user via audible means.

17. The method of claim 14, wherein the communication terminal device issues the warning to the user by visible means.

18. The method of claim 13, wherein the general communication channel is configured to transmit a general communication using a general communication frequency.

19. The method of claim 18, wherein the special communication channel is configured to transmit the urgent communication using a special communication frequency.

20. The method of claim 19, wherein the special communication frequency is different from the general communication frequency.
